(19) United States
(12) Patent Application Publication
(10) Pub. No.: US 2026/0045897 A1
(43) Pub. Date: Feb. 12, 2026

(54) NOVEL PWM CONTROL METHOD FOR ECM MOTOR

(71) Applicant: ZHONGSHAN BROAD-OCEAN MOTOR CO., LTD., Zhongshan (CN)

(72) Inventors: Xiansheng ZHANG, Zhongshan (CN); Feilai LI, Zhongshan (CN); Hairong SUN, Zhongshan (CN); Wei LEI, Zhongshan (CN); Guiwen FU, Zhongshan (CN)

(21) Appl. No.: 19/291,084

(22) Filed: Aug. 5, 2025

(30) Foreign Application Priority Data
Aug. 6, 2024 (CN) 202411066949.1

(51) Int. Cl. H02P 23/14; H02P 23/00

(52) U.S. Cl. CPC H02P 23/14; H02P 23/0004

(57) ABSTRACT

A novel PWM control method is provided for an ECM motor. The ECM motor includes a motor controller and a motor unit. A microprocessor, an inverter circuit, and an interface circuit are provided on a motor control circuit board. The motor control circuit board is provided with a PWM input port, by means of which a PWM control signal from an external device is processed through the interface circuit and then input into the microprocessor. A plurality of sets of motor application parameters are stored in the motor controller, and the microprocessor detects a frequency of the input PWM signal, selects a corresponding set of motor application parameters based on the frequency of the input PWM signal, detects a duty cycle of the input PWM signal, and calculates a target operating value required for the motor based on the selected set of motor application parameters and the duty cycle. The method enables the ECM motor to be compatible with a variety of air conditioning load models, thereby significantly reducing motor part numbers and bringing great convenience to customers.

### RELATED APPLICATIONS

This application claims priority to Chinese Patent Application Ser. No. 202411066949.1, filed Aug. 6, 2024, the disclosure of which is incorporated by reference in its entirety.

### FIELD OF THE DISCLOSURE

The present invention relates to a novel PWM control method for an ECM motor.

### BACKGROUND

In recent years, with increasingly fierce competition in the field of electrical appliances, technical requirements for products have been continuously rising, such as requirements for energy conservation and environmental friendliness, high controllability and intelligence, short development cycles, and low noise of the products. As core components, motors have undoubtedly become key components for solving the above-mentioned technical problem. Motors in traditional household air conditioners are generally single-phase AC motors of the PSC type. However, such single-phase AC motors are low in efficiency, consume a lot of energy, generate large noise, and have low controllability and intelligence. With the advancement of motor technology, DC motors are gradually replacing AC motors. The DC motors are equipped with motor controllers, and use the motor controllers to achieve the purpose of electronic commutation of current. Therefore, in the industry, such motors are also referred to as ECM motors (electronically commutated motors) or brushless DC motors (BLDC motors). Such motors are characterized by high energy efficiency and environmental friendliness, high reliability and controllability, low noise, and case of intelligent control implementation, and can overcome shortcomings of single-phase AC motors. As a result, single-phase AC motors in existing air conditioning systems are being gradually replaced by brushless DC motors or ECM motors.

After years of market application, ECM motors with constant torque control or constant airflow control, which were developed in the early stage by major foreign air conditioner manufacturers, are now used across various load models. To facilitate application in different load models, newly developed alternative ECM motors require input parameter identification so as to match different load application parameters. This process is complicated, and it results in a large number of alternative ECM motors of different models, which is not conducive to manufacturers' management. Moreover, each alternative ECM motor of a different model requires a development cycle and development cost. In view of this, it is necessary to develop an alternative ECM motor compatible with a variety of air conditioning load models,

The purpose is to significantly reduce motor part numbers, and bringing great convenience to customers.

### SUMMARY

An object of the present invention is to provide a novel PWM control method for an ECM motor. In this method, a corresponding set of motor application parameters is selected based on a frequency of an input PWM signal, a duty cycle of the input PWM signal is detected, and a target operating value required for the motor is calculated based on the selected set of motor application parameters and the duty cycle. The method enables the ECM motor to be compatible with a variety of air conditioning load models, thereby significantly reducing motor part numbers and bringing great convenience to customers.

The object of the present invention is achieved by the following technical solution:

A novel PWM control method for an ECM motor, wherein the ECM motor includes a motor controller and a motor unit; the motor unit includes a stator assembly, a rotor assembly, and a housing assembly; the stator assembly is mounted inside the housing assembly; the stator assembly and the rotor assembly are magnetically coupled to each other; the motor controller includes a motor control circuit board; a microprocessor, an inverter circuit, and an interface circuit are provided on the motor control circuit board, wherein the microprocessor controls the inverter circuit, and the inverter circuit controls currents in coil windings of each phase of the stator assembly; and the motor control circuit board is provided with a PWM input port, by means of which a PWM control signal from an external device is processed through the interface circuit and then input into the microprocessor, wherein in the control method, a plurality of sets of motor application parameters are stored in the motor controller, and the microprocessor detects a frequency of the input PWM signal, selects a corresponding set of motor application parameters based on the frequency of the input PWM signal, detects a duty cycle of the input PWM signal, and calculates a target operating value required for the motor based on the selected set of motor application parameters and the duty cycle; the motor application parameters are torque application parameters or airflow application parameters, and the target operating value is a target torque value or a target airflow value.

The above-mentioned microprocessor outputs a feedback signal FG through the interface circuit to indicate a state of the motor.

The above-mentioned feedback signal FG is a PWM signal, and for the feedback signal FG, PWM signals of different frequency bands are used to indicate different horsepower ranges of the motor.

The above-mentioned feedback signal FG is a PWM signal used to feed back a rotational speed, and is output as a square-wave PWM signal with a 50% duty cycle; and there is a fixed corresponding relationship between a frequency f of the square-wave PWM signal with the 50% duty cycle and the rotational speed.

The above-mentioned feedback signal FG is a PWM signal used to feed back an actual current or power of the motor, and is output as a square-wave PWM signal with a duty cycle of 50%; and there is a fixed corresponding relationship between a frequency f of the square-wave PWM signal with the 50% duty cycle and the actual current or power of the motor. The above-mentioned plurality of sets of motor application parameters are at least three sets, with each set of motor application parameters including a maximum value and a minimum value of a motor application parameter.

The above-mentioned corresponding set of motor application parameters selected based on the frequency of the input PWM signal is airflow application parameters, the set of airflow application parameters includes a maximum airflow value Qmax and a minimum airflow value Qmin, and given that the duty cycle of the input PWM signal is Duty, an arbitrary target airflow is as follows:

$$Qn = Q min + ( 95 \% - Duty ) * ( Q max - Q min ) / ( 95 \% - 5 \% ) .$$

After the arbitrary target airflow Qn is obtained as described above, a motor bus power calibrated value corresponding to the arbitrary target airflow is calculated as Power_goal=K0+K1*Qn+K2*N+K3*Qn*N+K4*N*N, wherein K0, K1, K2, K3, and K4 are calculation coefficients of an airflow model function, and N represents the rotational speed; each set of airflow application parameters corresponds to a set of calculation coefficients of the airflow model function; and the calculation coefficients of the airflow model function are also stored in the motor controller.

A real-time power of the above-described motor is Power_actual=Vdc*Idc, wherein Vdc is a bus voltage, and Idc is a bus current; and the motor bus power calibrated value Power_goal is compared with the real-time motor power Power_actual, and a target rotational speed is continuously adjusted until a dynamic balance is achieved, thereby outputting a desired target airflow.

Compared with the prior art, the present invention has the following effects.

1) A plurality of sets of motor application parameters are stored in the motor controller, and the microprocessor detects a frequency of the input PWM signal, selects a corresponding set of motor application parameters based on the frequency of the input PWM signal, detects a duty cycle of the input PWM signal, and calculates a target operating value required for the motor based on the selected set of motor application parameters and the duty cycle; the motor application parameters are rotational speed application parameters, torque application parameters or airflow application parameters, and the target operating value is a target torque value or a target airflow value. The method enables the ECM motor to be compatible with a variety of air conditioning load models, thereby significantly reducing motor part numbers and bringing great convenience to customers.

2) Other advantages of the present invention are described in detail in embodiments.

### BRIEF DESCRIPTION OF THE DRAWINGS

FIG. 1 is a perspective view of an ECM motor of the present invention;

FIG. 2 is a perspective view of a motor controller of an ECM motor of the present invention;

FIG. 3 is a cross-sectional view of an ECM motor of the present invention;

FIG. 4 is a block diagram of an implementation circuit of a motor controller of an ECM motor of the present invention;

FIG. 5 is a circuit diagram corresponding to FIG. 4;

FIG. 6 is a schematic diagram of connection between an ECM motor of the present invention and a main control board of an air conditioning system;

FIG. 7 is a circuit diagram of an interface circuit of an ECM motor of the present invention; and

FIG. 8 is a flow diagram illustrating processing of an input PWM signal by an ECM motor of the present invention.

### DETAILED DESCRIPTION

The present invention will be further described in detail below using specific embodiments and with reference to the accompanying drawings.

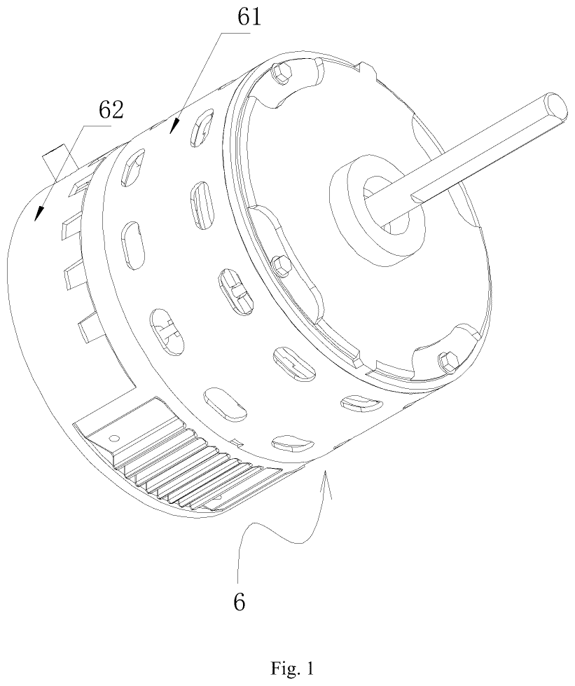

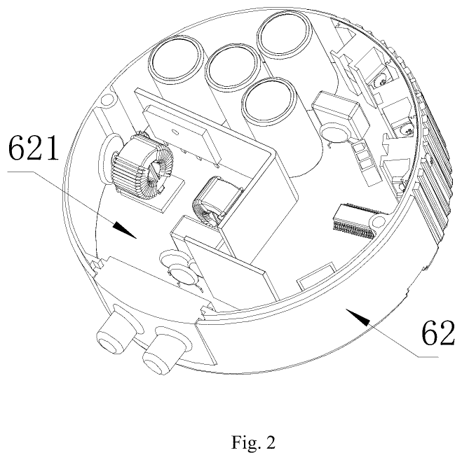

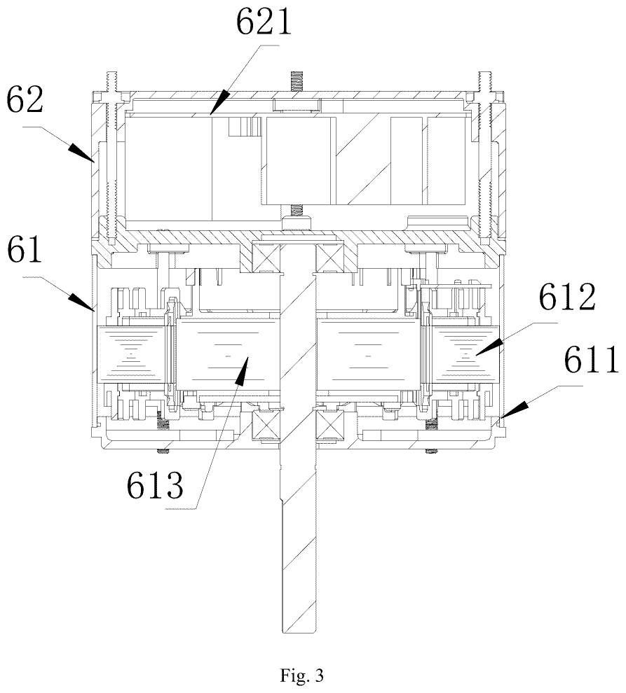

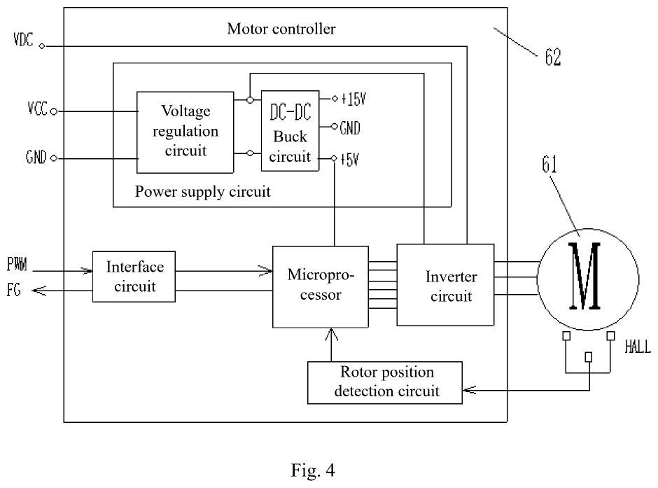

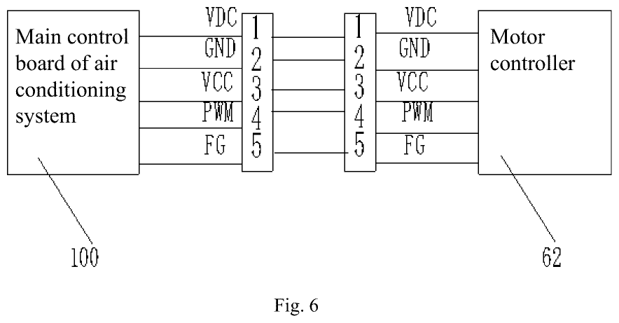

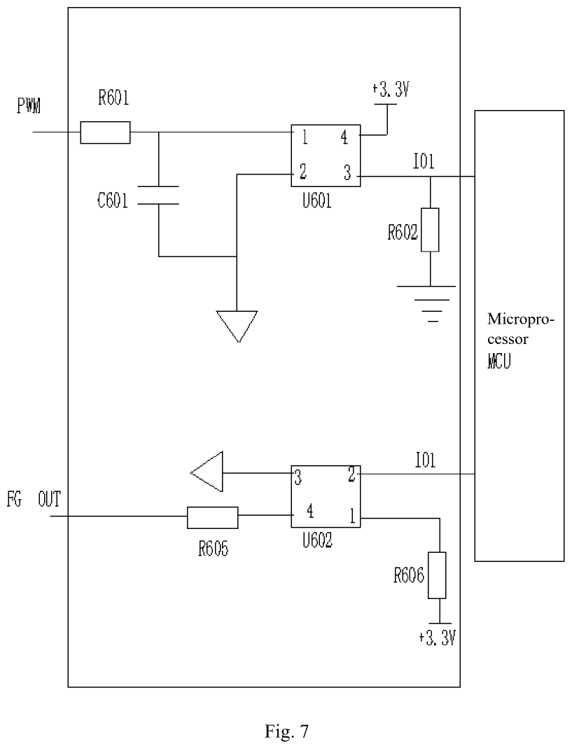

Embodiment 1: As shown in FIGS. 1 to 7, this embodiment relates to an ECM motor 6. The ECM motor 6 includes a motor controller 62 and a motor unit 61. The motor unit 61 includes a stator assembly 612, a rotor assembly 613, and a housing assembly 611. The stator assembly 612 is mounted inside the housing assembly 611. The stator assembly 612 and rotor assembly 613 are magnetically coupled to each other. The motor controller 62 includes a motor control circuit board 621. A microprocessor, an inverter circuit, and an interface circuit are provided on the motor control circuit board 621. The microprocessor controls the inverter circuit, and the inverter circuit controls currents in coil windings of each phase of the stator assembly 612. The motor control circuit board 621 is provided with five connection ports for connection to a main control board 100 of an air conditioning system. The five connection ports are: a grounding terminal GND connected to ground, a PWM input port, a DC bus voltage input port VDC, a low-voltage DC power input port VCC, and a motor feedback port. The motor feedback port outputs a feedback signal FG to indicate a state of the motor. The main control board 100 of the air conditioning system inputs a PWM signal to the ECM motor 6 through the PWM input port. The microprocessor calculates a set target airflow, target rotational speed, or target torque based on the input PWM signal. As shown in FIG. 4, a rotor position detection circuit detects a rotor position signal and inputs the rotor position signal to the microprocessor. The microprocessor controls the operation of the inverter circuit. The inverter circuit controls the energization and de-energization of the coil windings of each phase of the stator assembly 612. The interface circuit includes two optocoupler isolation circuits. The PWM input port and the motor feedback port are connected to the microprocessor via the two optocoupler isolation circuits. Chips U601 and U602 in FIG. 7 are optocoupler chips. Two software program modules are provided inside the microprocessor, namely a PWM frequency identification module and a PWM duty cycle identification module, which are respectively configured to identify a frequency and a duty cycle of the input PWM signal.

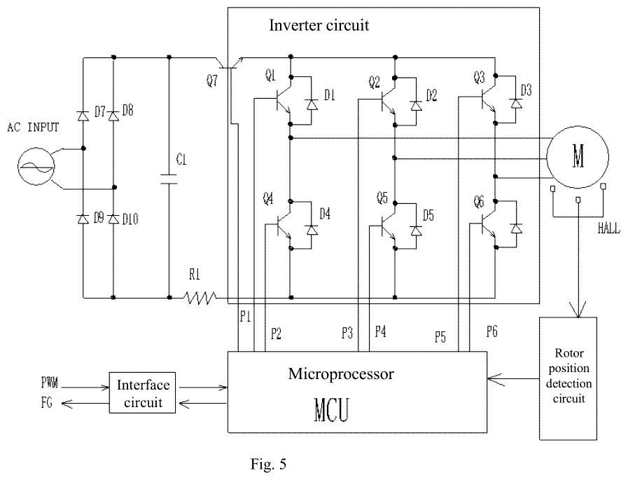

As shown in FIGS. 4 and 5, assuming that the ECM motor is a three-phase brushless DC permanent magnet synchronous motor, the rotor position detection circuit generally uses three Hall sensors HALL. Each of the three Hall sensors HALL detects a rotor position in a 360-degree electrical angle cycle. For every 120 degrees of electrical angle rotated, the energization of the coil windings of each phase of the stator assembly 12 is changed, thereby forming a 3-phase 6-step control mode. After an AC input (AC INPUT) passes through a full-wave rectifier circuit composed of diodes D7, D8, D9, and D10, resulting DC power is input into the inverter circuit composed of electronic switching transistors Q1, Q2, Q3, Q4, Q5, and Q6 and converted into three-phase AC power. Control terminals of the electronic switching transistors Q1, Q2, Q3, Q4, Q5, and Q6 are respectively controlled by six PWM signals (P1, P2, P3, P4, P5, and P6) output by the microprocessor. The motor control circuit board 621 has five connection ports: a grounding terminal GND connected to ground, a PWM input port, a DC bus voltage input port VDC, a low-voltage DC power input port VCC, and a motor feedback port.

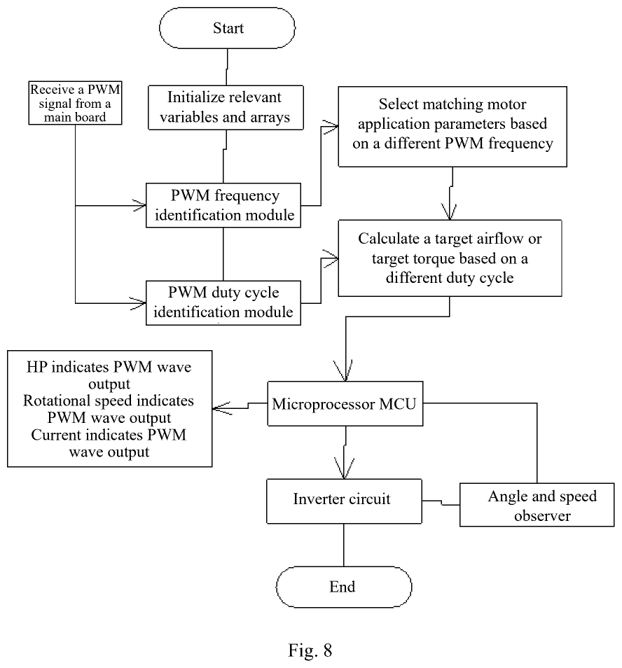

As shown in FIGS. 1 to 8, in a novel PWM control method for an ECM motor, the ECM motor 6 includes a motor controller 62 and a motor unit 61. The motor unit 61 includes a stator assembly 612, a rotor assembly 613, and a housing assembly 611. The stator assembly 612 is mounted inside the housing assembly 611. The stator assembly 612 and the rotor assembly 613 are magnetically coupled to each other. The motor controller 62 includes a motor control circuit board 621. A microprocessor, an inverter circuit, and an interface circuit are provided on the motor control circuit board 621. The microprocessor controls the inverter circuit, and the inverter circuit controls currents in coil windings of each phase of the stator assembly. The motor control circuit board 621 is provided with a PWM input port, by means of which a PWM control signal from an external device is processed through the interface circuit and then input into the microprocessor. In the control method, a plurality of sets of motor application parameters are stored in the motor controller, and the microprocessor detects a frequency of the input PWM signal, selects a corresponding set of motor application parameters based on the frequency of the input PWM signal, detects a duty cycle of the input PWM signal, and calculates a target operating value required for the motor based on the selected set of motor application parameters and the duty cycle. The motor application parameters are torque application parameters or airflow application parameters, and the target operating value is a target torque value or a target airflow value. The method enables the ECM motor to be compatible with a variety of air conditioning load models, thereby significantly reducing motor part numbers and bringing great convenience to customers.

The above-mentioned PWM control signal of the external device is a PWM control signal output by a main control board of an air conditioner.

The above-mentioned microprocessor outputs a feedback signal FG through the interface circuit to indicate a state of the motor.

The above-mentioned feedback signal FG is a PWM signal, and for the feedback signal FG, PWM signals of different frequency bands are used to indicate different horsepower ranges of the motor.

The above-mentioned feedback signal FG is a PWM signal used to feed back a rotational speed, and is output as a square-wave PWM signal with a 50% duty cycle; and there is a fixed corresponding relationship between a frequency f of the square-wave PWM signal with the 50% duty cycle and the rotational speed.

The above-mentioned feedback signal FG is a PWM signal used to feed back an actual current or power of the motor, and is output as a square-wave PWM signal with a duty cycle of 50%; and there is a fixed corresponding relationship between a frequency f of the square-wave PWM signal with the 50% duty cycle and the actual current or power of the motor.

The above-mentioned plurality of sets of motor application parameters are at least three sets, with each set of motor application parameters including a maximum value and a minimum value of a motor application parameter.

The above-mentioned corresponding set of motor application parameters selected based on the frequency of the input PWM signal is airflow application parameters, the set of airflow application parameters includes a maximum airflow value Qmax and a minimum airflow value Qmin, and given that the duty cycle of the input PWM signal is Duty, an arbitrary target airflow is as follows:

$$Qn = Q min + ( 95 \% - Duty ) * ( Q max - Q min ) / ( 95 \% - 5 \% ) .$$

After the arbitrary target airflow Qn is obtained as described above, a motor bus power calibrated value corresponding to the arbitrary target airflow is calculated as Power_goal=K0+K1*Qn+K2*N+K3*Qn*N+K4*N*N, wherein K0, K1, K2, K3, and K4 are calculation coefficients of an airflow model function, and N represents the rotational speed; each set of airflow application parameters corresponds to a set of calculation coefficients of the airflow model function; and the calculation coefficients of the airflow model function are also stored in the motor controller.

A real-time power of the above-described motor is Power_actual=Vdc*Idc, wherein Vdc is a bus voltage, and Idc is a bus current; and the motor bus power calibrated value Power_goal is compared with the real-time motor power Power_actual, and a target rotational speed is continuously adjusted until a dynamic balance is achieved, thereby outputting a desired target airflow.

The input PWM signal has two main characteristics: duty cycle and frequency. In the technical solution of the present invention, the adjustable duty cycle is used to control target torques or target airflows in different ranges, and the adjustable frequency is used to select different constant torque or constant airflow application parameters. A description is given below using an ECM motor with constant airflow control as an example.

1. PWM frequency ranges are defined through motor detection. A suitable tolerance may be set according to the actual precision. In this case, a tolerance of +/−3% is adopted.
A first set of airflow application parameters (airflow range: 200 CFM-1200 CFM) denoted by G1: 80 Hz+/−3%;
a second set of airflow application parameters (airflow range: 400 CFM-1400 CFM) denoted by G2: 90 Hz+/−3%;
a third set of airflow application parameters (airflow range: 500 CFM-1600 CFM) denoted by G3: 100 Hz+/−3%;
a fourth set of airflow application parameters (airflow range: 600 CFM-1800 CFM) denoted by G4: 110 Hz+/−3%;
a fifth set of airflow application parameters (airflow range: 800 CFM-2200 CFM) denoted by G5: 120 Hz+/−3%;
a sixth set of airflow application parameters denoted by G6: 130 Hz+/−3%;
a nth set of airflow application parameters denoted by Gn: n HZ+/−3%; and so forth.

The coefficients K0, K1, K2, K3, and K4 of the airflow model function required for each set of airflow application parameters are calculated as follows:

Calculation coefficient

| Coefficient | Hexadecimal | | Decimal |
|---|---|---|---|
| K0 | 67 | 08 | 2.6376 |
| K1 | 27 | F7 | 1.0231 |
| K2 | A4 | 3A | 4.2042 |
| −K3 | 11 | CC | 0.4556 |
| −K4 | 1C | 9F | 0.7327 |

The first set of airflow application parameters is used below as an example. After the airflow range is determined to be 200-1200 CFM based on the PWM frequency, an arbitrary target airflow is calculated as:

$$Qn = 200 + ( 95 \% duty ) * ( 1200 - 200 ) / ( 95 \% - 5 \% ) . \qquad ( formula 1 )$$

Given that 95% corresponds to a maximum airflow, and 5% corresponds to a minimum airflow, a bus power calibrated value corresponding to the arbitrary target airflow is calculated,

$$Power\_goal = K 0 + K 1 * Qn + K 2 * N + K 3 * Qn * N + K 4 * N * N . \qquad ( formula 2 )$$

Power_goal is calculated based on the above-mentioned five airflow coefficients selected for the first set and the formula 2.

The motor bus power calibrated value Power goal is compared with a real-time motor power Power_actual, and a target rotational speed is continuously adjusted until a dynamic balance is achieved, thereby outputting a desired target airflow.

The above embodiments are preferred implementations of the present invention, but the implementations of the present invention are not limited thereto. Any other changes, modifications, substitutions, combinations, and simplifications made without departing from the spirit essence and principles of the present invention shall be equivalents, and shall all be encompassed within the scope of protection of the present invention.

1. A novel PWM control method for an ECM motor, wherein the ECM motor comprises a motor controller and a motor unit; the motor unit comprises a stator assembly, a rotor assembly, and a housing assembly; the stator assembly is mounted inside the housing assembly; the stator assembly and the rotor assembly are magnetically coupled to each other;
the motor controller comprises a motor control circuit board; a microprocessor, an inverter circuit, and an interface circuit are provided on the motor control circuit board, wherein the microprocessor controls the inverter circuit, and the inverter circuit controls currents in coil windings of each phase of the stator assembly; and
the motor control circuit board is provided with a PWM input port, by means of which a PWM control signal from an external device is processed through the interface circuit and then input into the microprocessor,
wherein in the control method, a plurality of sets of motor application parameters are stored in the motor controller, and the microprocessor:
detects a frequency of the input PWM signal, selects a corresponding set of motor application parameters based on the frequency of the input PWM signal,
detects a duty cycle of the input PWM signal, and calculates a target operating value required for the motor based on the selected set of motor application parameters and the duty cycle;
the motor application parameters are torque application parameters or airflow application parameters, and the target operating value is a target torque value or a target airflow value.

2. The novel PWM control method for an ECM motor according to claim 1, wherein the microprocessor outputs a feedback signal FG through the interface circuit to indicate a state of the motor.

3. The novel PWM control method for an ECM motor according to claim 2, wherein the feedback signal FG is a PWM signal, and for the feedback signal FG, PWM signals of different frequency bands are used to indicate different horsepower ranges of the motor.

4. The novel PWM control method for an ECM motor according to claim 2, wherein the feedback signal FG is a PWM signal used to feed back a rotational speed, and is output as a square-wave PWM signal with a 50% duty cycle; and
there is a fixed corresponding relationship between a frequency f of the square-wave PWM signal with the 50% duty cycle and the rotational speed.

5. The novel PWM control method for an ECM motor according to claim 2, wherein the feedback signal FG is a PWM signal used to feed back an actual current or power of the motor, and is output as a square-wave PWM signal with a duty cycle of 50%; and
there is a fixed corresponding relationship between a frequency f of the square-wave PWM signal with the 50% duty cycle and the actual current or power of the motor.

6. The novel PWM control method for an ECM motor according to claim 1, the plurality of sets of motor application parameters are at least three sets, with each set of motor application parameters comprising a maximum value and a minimum value of a motor application parameter.

7. The novel PWM control method for an ECM motor according to claim 6, wherein the corresponding set of motor application parameters selected based on the frequency of the input PWM signal is airflow application parameters, the set of airflow application parameters comprises a maximum airflow value Qmax and a minimum airflow value Qmin, and given that the duty cycle of the input PWM signal is Duty, an arbitrary target airflow is as follows:
$$Qn = Q min + ( 95 \% - Duty ) * ( Q max - Q min ) / ( 95 \% - 5 \% ) .$$

8. The novel PWM control method for an ECM motor according to claim 7, wherein after the arbitrary target airflow Qn is obtained, a motor bus power calibrated value corresponding to the arbitrary target airflow is calculated as Power_goal=K0+K1*Qn+K2*N+K3*Qn*N+K4*N*N, wherein K0, K1, K2, K3, and K4 are calculation coefficients of an airflow model function, and N represents the rotational speed;
each set of airflow application parameters corresponds to a set of calculation coefficients of the airflow model function; and
the calculation coefficients of the airflow model function are also stored in the motor controller.

9. The novel PWM control method for an ECM motor according to claim 8, wherein a real-time motor power is Power_actual=Vdc*Idc, wherein Vdc is a bus voltage, and Idc is a bus current; and
the motor bus power calibrated value Power_goal is compared with the real-time motor power Power_actual, and a target rotational speed is continuously adjusted until a dynamic balance is achieved, thereby outputting a desired target airflow.
